(19) United States
(12) Patent Application Publication
(10) Pub. No.: US 2015/0103738 A1
(43) Pub. Date: Apr. 16, 2015

(54) SELECTING AN ACCESS POINT FOR DETERMINING POSITION OF A DEVICE BASED ON TRAFFIC LOAD INFORMATION

(71) Applicant: QUALCOMM Incorporated, San Diego, CA (US)

(72) Inventors: Sai Pradeep VENKATRAMAN, Santa Clara, CA (US); Saumitra Mohan DAS, Santa Clara, CA (US); Vinay SRIDHARA, Santa Clara, CA (US); Weihua GAO, San Jose, CA (US)

(73) Assignee: QUALCOMM Incorporated, San Diego, CA (US)

(21) Appl. No.: 14/055,571

(22) Filed: Oct. 16, 2013

(51) Int. Cl. H04W 48/20; H04W 64/00

(52) U.S. Cl. CPC H04W 48/20; H04W 64/003; H04W 48/14
USPC 370/328

(57) ABSTRACT

Techniques described herein enable a mobile device in selecting an access point (AP) from a plurality of APs for determining the position of the mobile device. In one aspect, the mobile device receives assistance data including traffic load information associated with one or more APs. The mobile device may determine which AP to communicate with based on the traffic load information associated with a plurality of APs. The assistance data including the traffic load information associated with the plurality of APs may be compiled using information from a controller connected to the plurality of APs, crowdsourcing (using information from a plurality of mobile devices over time), or information regarding the traffic conditions received from the plurality of APs. In one implementation, the mobile device may receive the assistance data information including the traffic load information from an assistance data (AD) Server.

### BACKGROUND

1. Technical Field

Aspects of the disclosure relate to computing technologies. In particular, aspects of the disclosure relate to mobile device technologies, such as systems, methods, apparatuses, and computer-readable media for selecting an access point from a plurality of access points for determining position of a mobile device.

2. Relevant Background

Different techniques for obtaining a position fix for a mobile device may be appropriate under different conditions. In an outdoor environment, satellite-based approaches, such as GNSS (Global Navigation Satellite System) techniques may be suitable, because the mobile device may be able to receive satellite-based positioning signals with specific timing requirements. Based on reception of such satellites signals, a position fix for the mobile device may be calculated. However, satellite-based approaches may be less effective in certain indoor environments, since acquiring satellite fixes for multiple satellites may be difficult due to physical and opaque obstructions between the mobile device and the satellites.

In indoor environments, such as a shopping mall, airport, sports arena, etc., access point (AP) based approaches are generally more useful for obtaining a position fix for a mobile device. The mobile device observes signals sent to and/or from APs at known locations. Different types of observations may be obtained such as RSSI (Received Signal Strength Indication) and RTP (Round-trip Time). Such observations may allow the mobile device to estimate its distance to each AP. The mobile device may then be able to triangulate and estimate its own location, based on the distances to different APs.

With the proliferation of wireless networks in venues such as malls, airports and large commercial buildings, there are often quite a large number of APs (e.g., 500 APs) operating at any given moment within a particular indoor environment. Selecting an AP from the large number of APs may require communicating with a large number of APs to determine their availability. Generally, determining location based on RTT calculations is computationally intensive and requires communicating with each AP individually. The mobile device may end up expending time and power with retries to APs that have significant traffic and may not be able to service positioning requests.

Embodiments of the invention solve this and other problems.

### SUMMARY

According to one or more aspects of the disclosure, techniques described herein enable a mobile device in selecting an access point (AP) from a plurality of APs for determining the position of the mobile device. In other embodiments, the mobile device may also communicate with an AP for accessing a data network.

In one aspect, the mobile device receives assistance data (AD) including traffic load information associated with one or more APs. The mobile device may communicate with one or more of the APs from the plurality of APs based on the traffic load information associated with the one or more APs. The AD may be compiled using information from the controller connected to the plurality of APs, crowdsourcing using a plurality of mobile devices over time, or information regarding the traffic conditions received from the APs. In one implementation, the AD information, including the traffic load information for the APs, may be sent to the mobile device by an Assistance Data (AD) Server.

An example method for selecting at least one access point (AP) from a plurality of APs for determining position of a mobile device may include receiving, at the mobile device, assistance data (AD) information, wherein the AD information may include position information and traffic load information associated with the at least one AP from the plurality of APs, and communicating with the at least one AP based on the traffic load information. In certain implementations, communicating may further include exchanging information with the at least one AP for accessing information from a data network. Some embodiments may further include performing retries for communicating with the at least one AP based on the traffic load information, wherein a number of retries for communicating with the at least one AP may be inversely proportional to the traffic load information associated with the at least one AP.

In one example embodiment of the method, the traffic load information for the at least one AP may include one or more of a number of mobile devices connected to the at least one AP, a number of other APs operating over a frequency channel used by the at least one AP, and/or amount of traffic on the frequency channel. In some aspects, the traffic load information for the at least one AP may originate from a controller, a second mobile device and/or the at least one AP.

In certain example embodiments, the AD information may include the position information and the traffic load information associated with the plurality of APs. In one aspect, communicating with the at least one AP may further include determining if the plurality of APs are more than a predetermined number, ranking the plurality of APs based on the traffic load information and communicating with the at least one AP from the plurality of APs based on the ranking of the plurality of the APs. In one example implementation, the traffic load information associated with the plurality of APs may be indicated by assigning a numeric value to each of the plurality of APs in the AD information.

In certain example implementations of the method, the AD information may be stored at an assistance data server and may be communicated to the mobile device by the assistance data server. In one implementation of the method, the AD information may be communicated by an AP to the mobile device.

An example mobile device for selecting at least one access point (AP) from a plurality of APs for determining position of the mobile device may include a processor coupled to memory, a transceiver configured to receive assistance data (AD) information, wherein the AD information may include position information and traffic load information associated with the at least one AP from the plurality of APs. The transceiver may be further configured to communicate with the at least one AP based on the traffic load information. In certain implementations, communicating may further include exchanging information with the at least one AP for accessing information from a data network. Some embodiments may further include performing retries by the processor for communicating using the transceiver with the at least one AP based on the traffic load information, wherein a number of retries for communicating with the at least one AP may be inversely proportional to the traffic load information associated with the at least one AP.

In one example embodiment of the mobile device, the traffic load information for the at least one AP may include one or more of a number of mobile devices connected to the at least one AP, a number of other APs operating over a frequency channel used by the at least one AP, and/or amount of traffic on the frequency channel. In some aspects, the traffic load information for the at least one AP may originate from a controller, a second mobile device and/or the at least one AP.

In certain example embodiments of the mobile device, the AD information received by the transceiver of the mobile device may include the position information and the traffic load information associated with the plurality of APs. In one aspect, communicating with the at least one AP may further include determining by the processor if the plurality of APs are more than a predetermined number, ranking, by the processor, the plurality of APs based on the traffic load information and communicating with the at least one AP from the plurality of APs based on the ranking of the plurality of the APs. In one example implementation, the traffic load information associated with the plurality of APs may be indicated by assigning a numeric value to each of the plurality of APs in the AD information.

In certain example implementations of the mobile device, the AD information may be stored at an assistance data server in its memory and may be communicated to the mobile device by the assistance data server. In one implementation, the AD information may be communicated by an AP to the mobile device.

An example method for transmitting traffic load information for at least one access point (AP) from a plurality of APs for determining position of a mobile device, may include receiving traffic load information associated with the at least one AP from the plurality of APs and generating an assistance data (AD) list comprising assistance data (AD) information, wherein the AD information may include position information and the traffic load information associated with the at least one AP from the plurality of APs. The method may further include transmitting the AD list for delivery to the mobile device, wherein the traffic load information from the AD list may be used by the mobile device in selecting the at least one AP for communicating with for determining the position of the mobile device. In one example, the method is performed by a server computer.

In one example embodiment of the method, the AD list may include the position information and the traffic load information associated with the plurality of APs. In one implementation, generating the AD list may further include ranking the plurality of APs based on the traffic load information associated with each of the plurality of APs, and including the ranking information for each of the plurality of APs in the AD list.

In certain embodiment of the method, the traffic load information for the at least one AP may include one or more of a number of mobile devices connected to the at least one AP, a number of other APs operating over a frequency channel used by the at least one AP, and/or amount of traffic on the frequency channel. In one aspect, the traffic load information for the at least one AP is received from one or more of a controller, a second mobile device, or the at least one AP.

An example server computer for transmitting traffic load information for at least one access point (AP) from a plurality of APs for determining position of a mobile device, may include a transceiver configured to receive traffic load information associated with the at least one AP from the plurality of APs, a processor coupled to memory and configured to generate an assistance data (AD) list comprising assistance data (AD) information, wherein the AD information may include position information and the traffic load information associated with the at least one AP from the plurality of APs, and the transceiver further configured to transmit the AD list for delivery to the mobile device, wherein the traffic load information from the AD list may be used by the mobile device in selecting the at least one AP for communicating with for determining the position of the mobile device.

In one example embodiment of the server computer, the AD list generated by the server computer may include the position information and the traffic load information associated with the plurality of APs. In one implementation, the processor may be further configured to generate a ranking of the plurality of APs based on the traffic load information associated with each of the plurality of APs, and include the ranking information for each of the plurality of APs in the AD list.

In certain example embodiments of the server computer, the traffic load information, received by the transceiver of the server computer, for the at least one AP may include one or more of a number of mobile devices connected to the at least one AP, a number of other APs operating over a frequency channel used by the at least one AP, and/or amount of traffic on the frequency channel. In one aspect, the traffic load information for the at least one AP is received by the transceiver of the server computer from one or more of a controller, a second mobile device, or the at least one AP.

The foregoing has outlined rather broadly features and technical advantages of examples in order that the detailed description that follows can be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

Aspects of the disclosure are illustrated by way of example. The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 illustrates a configuration that includes a controller, a plurality of APs and a mobile device for performing embodiments of the invention.

FIG. 2 illustrates another configuration that includes a controller, a plurality of APs and a mobile device for performing embodiments of the invention.

FIG. 3 illustrates another configuration with a number of APs, an AD Server and a mobile device.

FIG. 4 illustrates yet another configuration with a number of APs, an AD Server and a mobile device.

FIG. 5 illustrates a configuration with a plurality of mobile devices, APs and an AD Server.

FIG. 6 illustrates one embodiment of the AD Server, in accordance with some embodiments.

FIG. 7 illustrates another embodiment of the AD Server, in accordance with some embodiments.

FIG. 8 illustrates a block diagram for example modules implemented in a mobile device according to one embodiment of the invention.

FIG. 9 illustrates a block diagram for example modules implemented in an AD Server according to one embodiment of the invention.

FIG. 10 is a flow diagram illustrating a method for performing embodiments of the invention according to one or more illustrative aspects of the disclosure.

FIG. 11 is a flow diagram illustrating another method for performing embodiments of the invention according to one or more illustrative aspects of the disclosure.

FIG. 12 is another flow diagram illustrating a method for performing embodiments of the invention according to one or more illustrative aspects of the disclosure.

FIG. 13 illustrates an example computing device incorporating parts of the device employed in practicing embodiments of the invention.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Prior to discussing embodiments of the invention, description of some terms may be helpful in understanding embodiments of the invention.

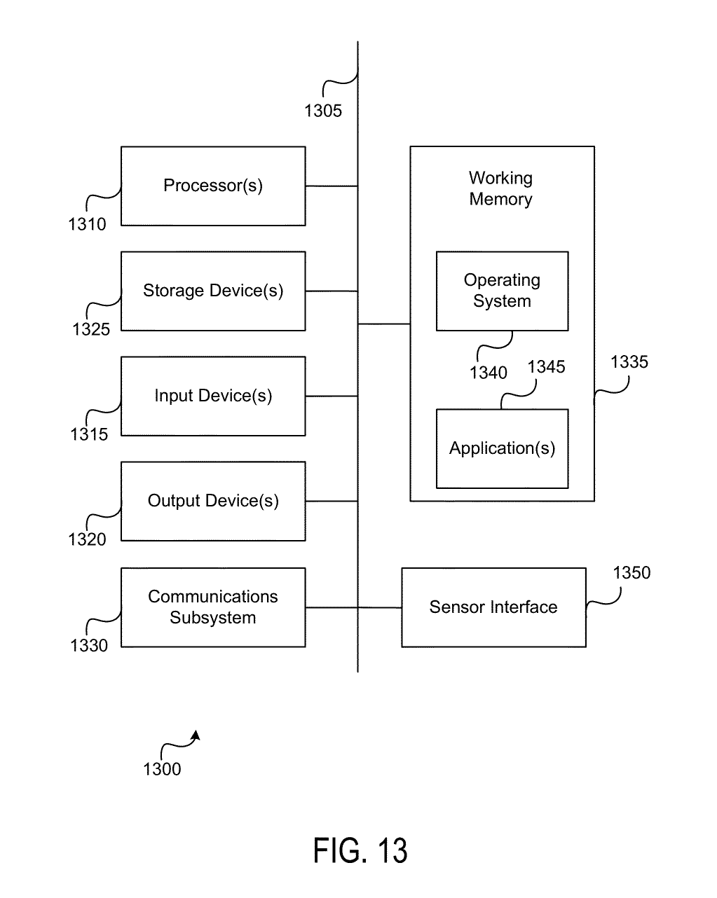

As described herein, in one embodiment of the invention, a “mobile device” may refer to any electronic device that may be transported and operated by a user. Examples of mobile devices may include, but are not limited to, mobile phones (e.g. cellular phones), PDAs, tablet computers, net books, laptop computers, personal music players, hand-held specialized readers, wearable devices, etc. The mobile device may be implemented using one or more components described in FIG. 13.

As described herein, in one embodiment of the invention, an “access point (AP)” may refer to a device that allows wireless devices, such as mobile devices, to connect to a wired network using a wireless protocol. WiFi is an example of one such wireless protocol, however, any other suitable protocol may be used. The AP generally may connect to a router (via a wired network) as a standalone device, but it may also be an integral component of the router itself In one implementation, one or more APs may connect to a controller that may provide bandwidth and resource management for the APs. The AP may be implemented using one or more components described in FIG. 13.

As described herein, in one embodiment of the invention, a “controller”, may refer to a device that provides bandwidth and resource management amongst several APs connected to the controller. The controller may have visibility into factors leading to congestion at various APs connected to the controller. For example, the controller may detect that two APs are providing wireless coverage to an overlapping region and several mobile devices are within the range of the two APs. In response, in one implementation, the controller may designate separate channel frequencies for the two APs and may also cap the number of mobile devices that may connect to either of the APs to control congestions. The controller may be implemented using one or more components described in FIG. 13.

Aspects of the disclosure relate to mobile device technologies, such as systems, methods, apparatuses, and computer-readable media for selecting an AP from a plurality of APs for determining the position of the mobile device. This invention provides a novel approach for selecting suitable APs to be used in obtaining a position fix for a mobile device. In one implementation, the selection of an AP from a plurality of APs may be based on the traffic conditions and congestion at one or more of the APs.

Obtaining a position fix for a mobile device has become a critically important function in recent years. For mobile devices, there are countless applications that take advantage of the position fix of the device. For example, a map application may select appropriate maps, direction, driving routes, etc., based on the current location of the mobile device. A social networking application may identify other users within the vicinity based on the location of the device. Many other examples exist.

Different techniques for obtaining a position fix for a mobile device may be appropriate under different conditions. In an outdoor environment, satellite-based approaches, such as GNSS (Global Navigation Satellite System) techniques may be suitable, since the mobile device may be able to receive satellite-based positioning signals with specific timing requirements. Based on reception of such satellites signals, a position fix for the mobile device may be calculated. However, satellite-based approaches may be less effective in certain indoor environments, since acquiring satellite fixes for multiple satellites may be difficult due to physical and opaque obstructions between the mobile device and the satellites.

In indoor environments, such as a shopping mall, airport, sports arena, etc., access point (AP)-based approaches are generally more useful for obtaining a position fix for a mobile device. The mobile device observes signals sent to and/or from APs at known locations. Different types of observations may be obtained such as RSSI (Received Signal Strength Indication) and RTP (Round-trip Time). Such observations allow the mobile device to estimate its distance to each AP. The mobile device may then triangulate and estimate its own location, based on the distances to different APs.

In an AP-based approach, the mobile device may have difficulty selecting one or more APs out of a plurality of APs for determining the mobile device's position. With the proliferation of wireless networks in venues such as malls, airports and large commercial buildings, there are often quite a large number of APs (e.g., 500 APs) operating at any given moment within a particular indoor environment. The mobile device may discover several of these APs at each passive or discovery scan. Generally, location calculations based on observations of signals, to calculate the RTT are computationally intensive and may require communicating with each AP individually. The mobile device may end up expending time and power with retries to APs that have significant traffic. In heavy traffic conditions, it may be beneficial to limit the number of APs that are being probed for calculating the RTT, especially if some of those APs are already operating under heavy traffic conditions.

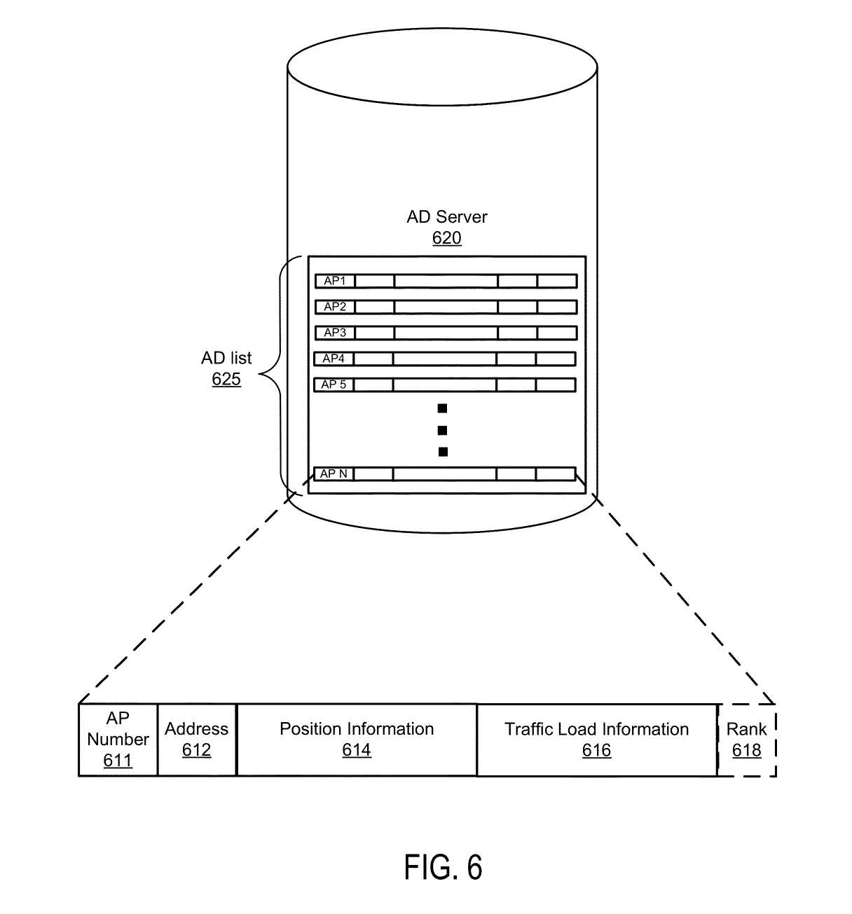

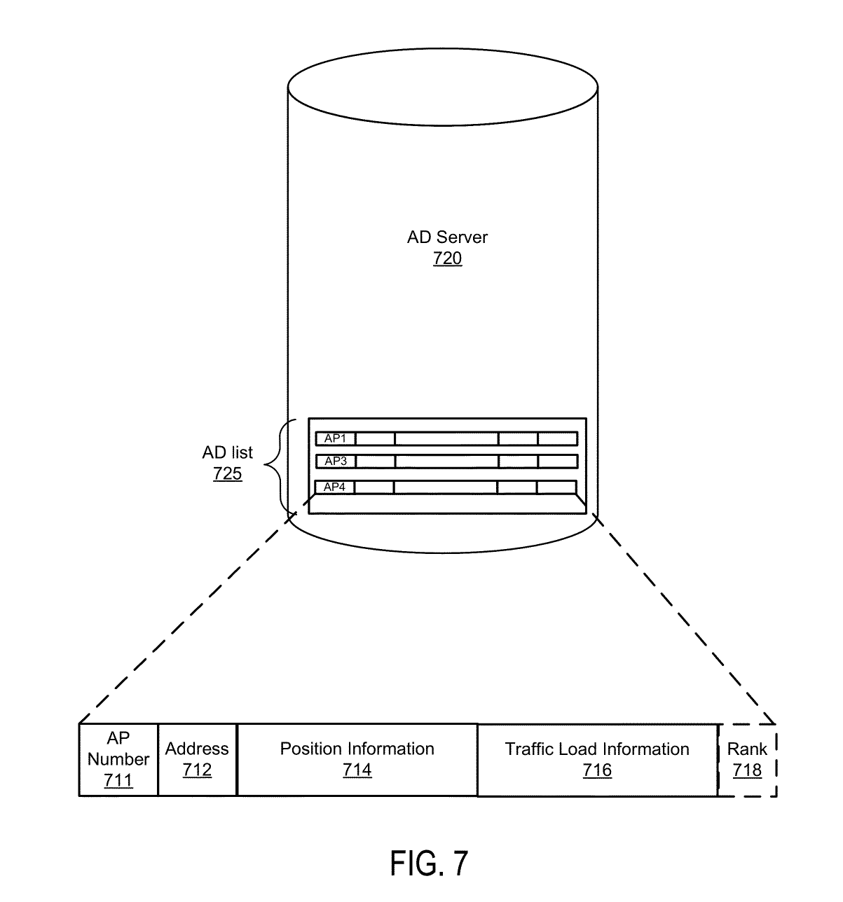

In one embodiment, the mobile device receives assistance data. The assistance data may include traffic load information for the AP. The mobile device may receive assistance data for a plurality of APs using an AD list, wherein the AD list may include assistance data information for one or more APs. FIG. 6 and FIG. 7 discuss examples of AD lists, according to some embodiments of the invention. The assistance data (and the AD lists) may be compiled using information from a controller connected to the plurality of APs, crowdsourcing (using information from a plurality of mobile devices over time), or information regarding the traffic conditions received from the APs. In one implementation, the mobile device may receive the traffic load information from an Assistance Data (AD) Server.

In some embodiments, the mobile device may use the traffic load information provided along with the assistance data in determining which AP to communicate with. For example, the mobile device may use the traffic load information included in AD information to determine APs that have a lighter traffic load. APs with lighter traffic loads may be able to respond to requests from the mobile device in a more timely manner than APs that are experiencing a higher traffic load.

Furthermore, the mobile device may receive the traffic load information associated with a plurality of APs using a single or a few AD lists from an AD Server. The AD Server may be a server computer implemented using one or more components described in FIG. 13. This may generally reduce traffic by reducing the number of requests from the mobile device to APs. Techniques described herein may also reduce the time needed by the mobile device for establishing communication with one or more APs that may be able to service the mobile device's requests. For example, using techniques described herein, the mobile device may be able to get a position fix faster by virtue of being able to communicate with APs that may respond to the mobile devices positioning requests in a timely manner.

Moreover, the mobile device may be able to request the AD lists containing AD information for one or more APs for various coverage areas from one or more AD Servers ahead of time. This may allow the mobile device to plan ahead for the potential APs the mobile device may communicate with on its projected route allowing for faster position fixes and/or wireless connections as the mobile devices moves along the projected route. Also, the mobile device may receive periodic updates from the AD Server based on changes in the traffic loads for the various APs, accounting for the dynamic nature of the traffic conditions for the APs.

Although, embodiments described herein, discuss a mobile device establishing a channel of communication with one or more APs for the purposes of obtaining a position fix, embodiments of the invention may not be limited to this use. For example, the mobile device may establish a channel of communication with one or more APs for the purpose of connecting to the internet or intranet through a data network. Embodiments described herein may enable quick identification of APs that are available for establishing a data communication channel between the mobile device and one or more APs resulting in faster connections and lower down time as the mobile device moves from one coverage area to another. Embodiments of the invention may also help system wide load balancing of traffic allowing for better utilization of the wireless bandwidth within a coverage area.

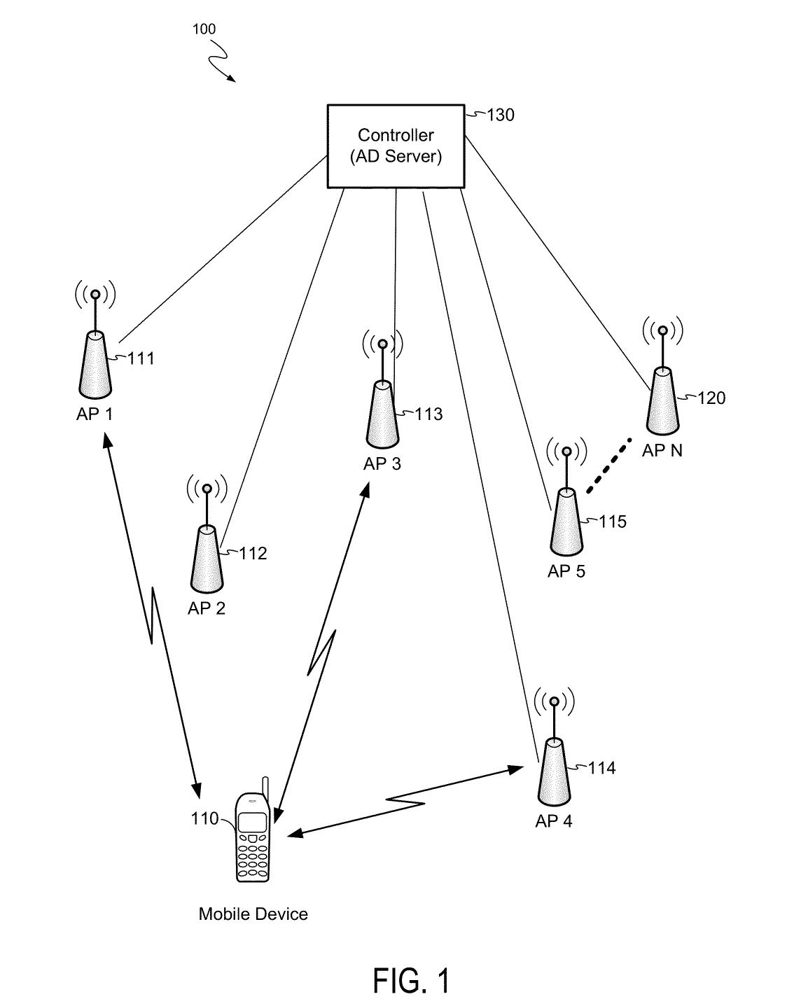

FIG. 1 illustrates a configuration 100 that includes a controller, a plurality of APs and a mobile device for performing embodiments of the invention. FIG. 1 illustrates an example configuration 100, wherein several APs are coupled to a controller 130. In one implementation, the APs are coupled to the controller 130 through a wireline, however wireless means may also be used in variations of the implementation. Although, only one controller 130 is shown in FIG. 1, in indoor settings, such as malls or libraries, a plurality of controllers may be used to connect several mobile devices 130 over a larger geographic area to the network and/or the internet through several wireless APs.

In FIG. 1, AP 1 (111), AP 2 (112), AP 3 (113), AP 4 (114), AP 5 (115) and AP N (120) are all coupled to the controller 130. The controller 130 may have information about the APs coupled to the controller 130 and may assess the traffic load information associated with the APs. In one implementation, an assistance data (AD) Server may be implemented within the controller 130 or tightly coupled to the controller 130. The AD Server may collect the traffic load information associated with each AP. In one embodiment, the AD Server may compile an AD list comprising AD information for the APs coupled to the controller. In addition, the AD Server may include traffic load information associated with each AP represented in the list.

In one scenario, the mobile device 110 may enter the area of coverage for the APs coupled to the controller 130. In one implementation, the mobile device 110 receives the AD list generated by the controller 130, comprising assistance data for positioning of the mobile device 110 and traffic load information for the APs coupled to the controller 130. In one implementation, the mobile device 110 may receive the AD list from the controller 130 through one of the APs. For example, one of the plurality of APs may be designated as the AP for dynamically providing updated AD lists generated by the controller 130 to the mobile devices entering into the coverage area.

The mobile device 110 may compute the relative congestion associated with each AP. In one implementation, the mobile device 110 may use the traffic load information associated with each AP from the AD list for computing the relative congestion associated with each AP represented in the AD list. In one aspect, the mobile device 110 may rank or access a ranked list to determine the order in which to communicate with the APs. For example, the mobile device 110 may attempt to communicate with AP devices that are ranked first, second, third and so on, in that order.

For the purposes of positioning itself, the mobile device 110 may initiate communication with APs having lowest congestion for obtaining additional positioning information. For example, as shown in FIG. 1, the mobile device 110 may communicate with AP 1 (111), AP 3 (113), and AP 4(114) for receiving information for positioning. In one implementation, the mobile device 110 may calculate the round trip time (RTT) for transmissions between the mobile device 110 and the APs (111, 113 and 114) for determining the distance between the mobile device 110 and the APs. The mobile device 110 may triangulate its own location using the distance between the mobile device 110 and the APs and positional information from the AD entries from the AD list. In one scenario, represented by configuration 100, the mobile device 110 may communicate position information with other APs besides AP 2 based on the determination that even though AP 2 (112) is closer to the mobile device 110 than the other APs (e.g., AP 1, AP 3, and AP 4), AP 2 may have a higher traffic load and may be slower to respond to positioning requests.

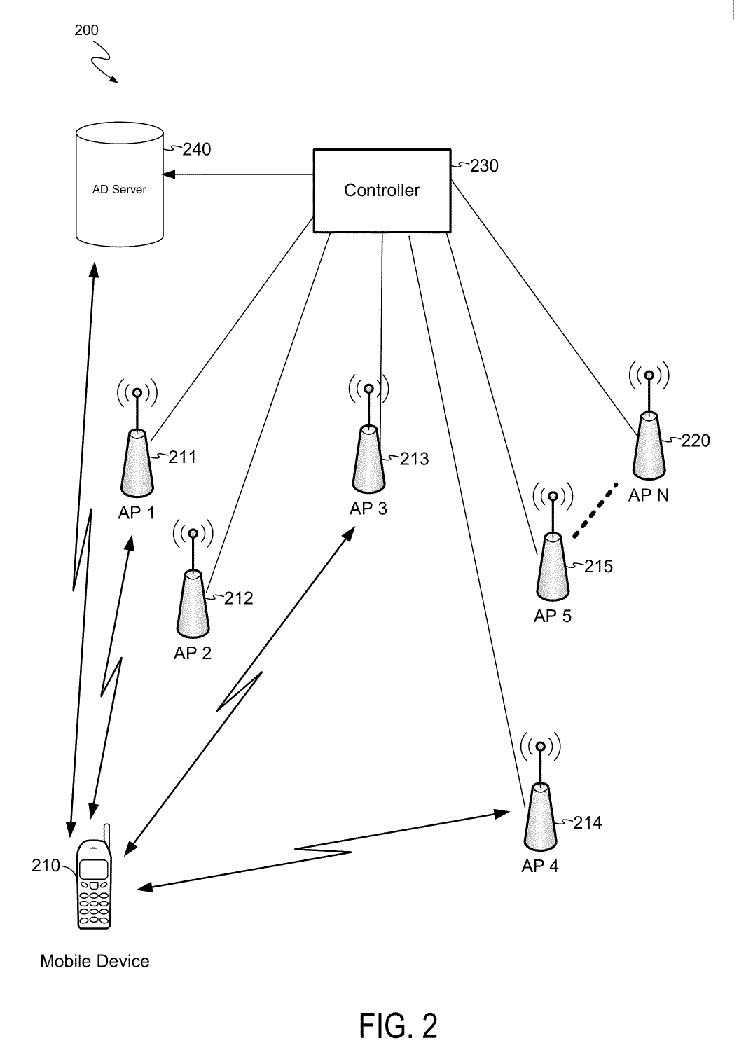

FIG. 2 illustrates another configuration 200 that includes a controller, a plurality of APs and a mobile device for performing embodiments of the invention. In the configuration 200 shown in FIG. 2, the controller 230 may forward information regarding the traffic conditions for one or more APs to an AD Server 240. For example, the controller 230 may forward information such as number of mobile devices connected to the APs, the frequency channels in use by the APs, traffic conditions for the various APs and other suitable information to the AD Server 240. The AD Server 240 may calculate traffic load information using the information received from the controller 230 for each of the APs.

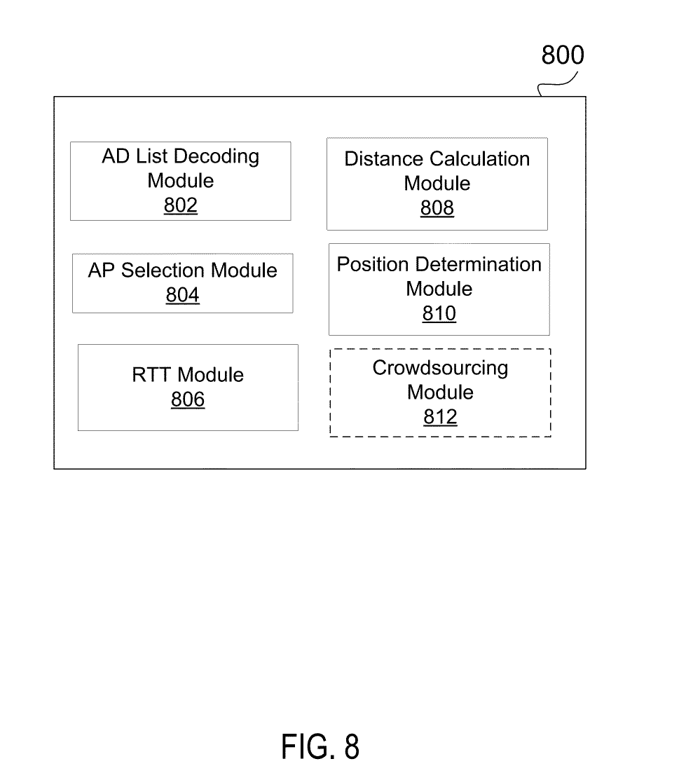

As shown in FIG. 2, the AD Server 240 and the controller 230 may be distinct devices coupled to each other. In one embodiment, AD Server 240 and controller 230 may be implemented using one or more components described in further detail in FIG. 13. The AD Server 240 may generate an AD list comprising information regarding several APs. The information for the APs may also explicitly or implicitly comprise traffic load information. For example, in one implementation, the traffic load information may be indicated by a ranking of all or most of the APs coupled to the controller 230. In another implementation, the APs may be grouped into multiple buckets or tagged with different classifiers to indicate a predetermined level of traffic conditions associated with each bucket/tag and the buckets or groupings may be ranked against each other. In another implementation, the traffic load information may be implicitly included in the AD list by omitting information regarding APs that have a high traffic load or are not optimally capable of responding to requests. FIG. 7 and FIG. 8 discuss in greater detail various techniques for generating AD lists using traffic load information.

As the mobile device 210 enters the area of coverage for the APs coupled to the controller 230, in one implementation, the mobile device 210 may receive an AD list. The AD list may include assistance data information and traffic load information for the APs coupled to the controller 130. In the configuration 200 shown in FIG. 2, the mobile device 210 may receive the AD list from the AD Server 240. In one implementation, the AD list is received by the mobile device 210 from the AD Server 240 using a wireless connection. In one implementation, each coverage area may have an AP designated for communicating updated AD lists from the AD Server 240 to the mobile device 210 entering or operating within the area of coverage. In another implementation, the mobile device 210 may download the AD list for the coverage area for the controller 230 from a remote server prior to visiting the area or during its visit to the area.

In one embodiment, the mobile device 210 may compute the relative congestion associated with each AP using the traffic load information associated with each AP. In one implementation, the mobile device 210 may rank or access the ranked list (generated by the AD Server 240) to determine the order in which to attempt communication with the APs. For example, the mobile device 210 may first attempt communication with AP devices that are ranked first, second, third and so on, in that order.

For the purposes of positioning itself, the mobile device 210 may initiate communication with the highest ranked APs for obtaining positioning information. For example, as shown in FIG. 2, the mobile device 210 may communicate with AP 1 (211), AP 3 (213), and AP 4 (214) for receiving information for positioning. For example, the mobile device 210 may calculate the round trip time (RTT) for transmissions between the mobile device 210 and the APs (211, 213 and 214) and triangulate its own location.

In one scenario, represented by configuration 200, the mobile device 210 may communicate position information with other APs besides AP 2 (212) based on the determination that even though AP 2 (212) is closer to the mobile device 210 than the other APs (e.g., AP 1, AP 3, and AP 4), AP 2 may have a higher traffic load and may be slower to respond to positioning requests. AP 5 (215) and other APs, including AP N (220) may also have higher traffic loads or may be further away for establishing a good communication channel for the purposes of communicating.

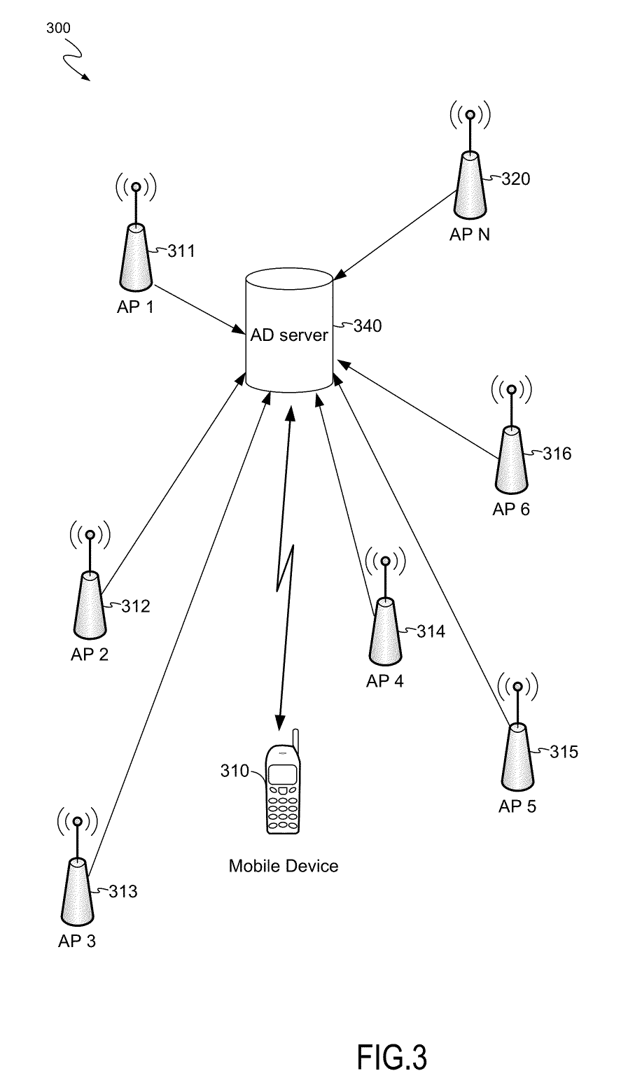

FIG. 3 illustrates yet another configuration 300 with a number of APs, an AD Server and a mobile device. Even though only one mobile device 310 is shown in example configuration 300 of FIG. 3, a plurality of mobile devices may be operating in each other's vicinity. As shown in example configuration 300 of FIG. 3, the configuration of the APs may be organized in an ad-hoc configuration without a controller. In such a configuration, each AP (e.g., AP 1 (311), AP 2 (312), AP 3 (313), AP 4 (314), AP 5 (315), AP 6 (316), AP N (320)) may send their most current traffic load information to the AD Server 340.

The AD Server 340 may compile an AD list comprising assistance data information that includes positioning information and traffic load information associated with each of the APs. The AD Server 340 may send the AD list to the mobile device 310. In one implementation, the AD Server 340 may send the AD list to the mobile device 310 using a wireless connection. In one implementation, each coverage area may have an AP designated for communicating updated AD lists from the AD Server 340 to the mobile devices entering the area of coverage. In another implementation, the mobile device 310 may download the AD list for the coverage area from the AD Server 340 prior to visiting the area or during the mobile device's visit to the area.

As discussed previously with reference to FIG. 1 and FIG. 2, the mobile device 310 may communicate with the APs with the least traffic loads. The mobile device 310 may determine the APs with the least traffic load using traffic load information from the AD list associated with each AP.

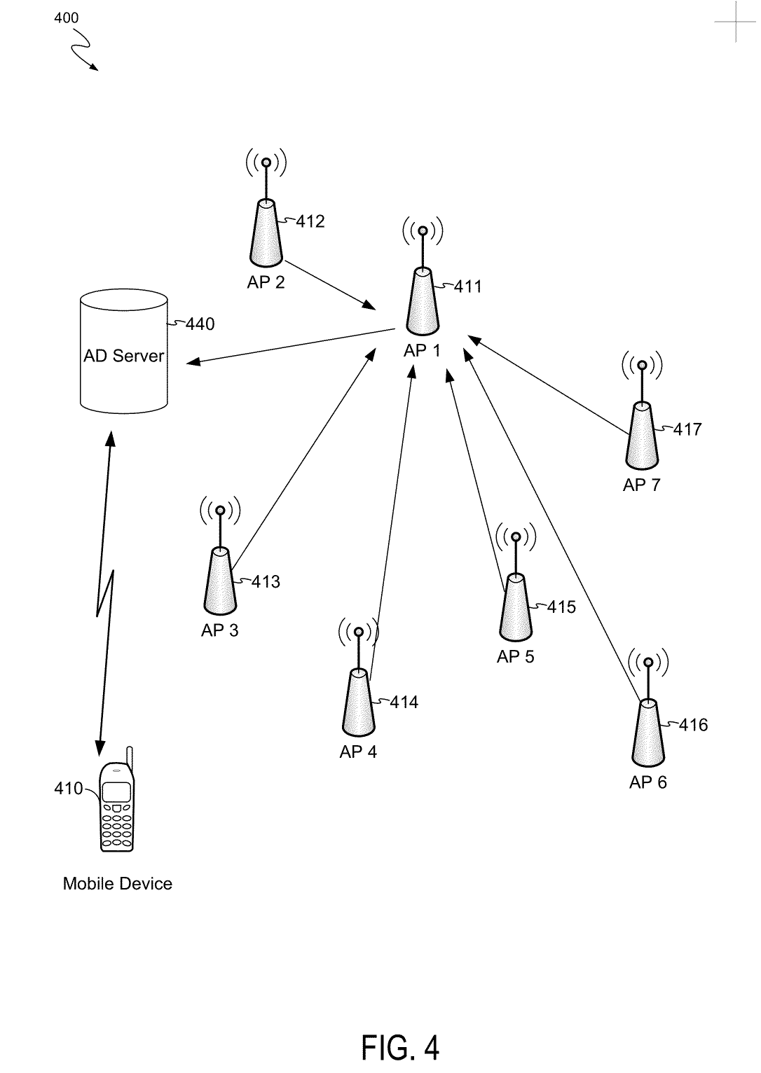

FIG. 4 illustrates yet another configuration 400 with a number of APs, an AD Server and a mobile device. Even though only one mobile device 410 is shown in the configuration 400 of FIG. 4, a plurality of mobile devices may be operating in each other's vicinity. FIG. 4 is similar to FIG. 3 in that each of the APs communicate their own traffic load information to the AD Server 440. However, configuration 400 may have a master AP 1(411) for aggregating traffic load information from a plurality of APs (AP 2 (412), AP 3 (413), AP 4 (414), AP 5 (415), AP 6 (416), and AP 7 (417)). After aggregating information from the plurality of APs, the master AP 1 (411) may send the traffic load information from the plurality of APs to the AD Server 440.

The AD Server 440 may compile an AD list using the traffic load information associated with each of the plurality of APs. The AD Server 440 may transmit the AD list to the mobile device 410. In one embodiment, the mobile device 410 may use the traffic load information associated with each of the APs in determining the APs to communicate with. For example, the mobile device 410 may commence communication with APs with lower traffic loads. In one implementation, the mobile device 410 communicates with a plurality of APs for establishing its own position relative to APs using position determining techniques, such as triangulation techniques.

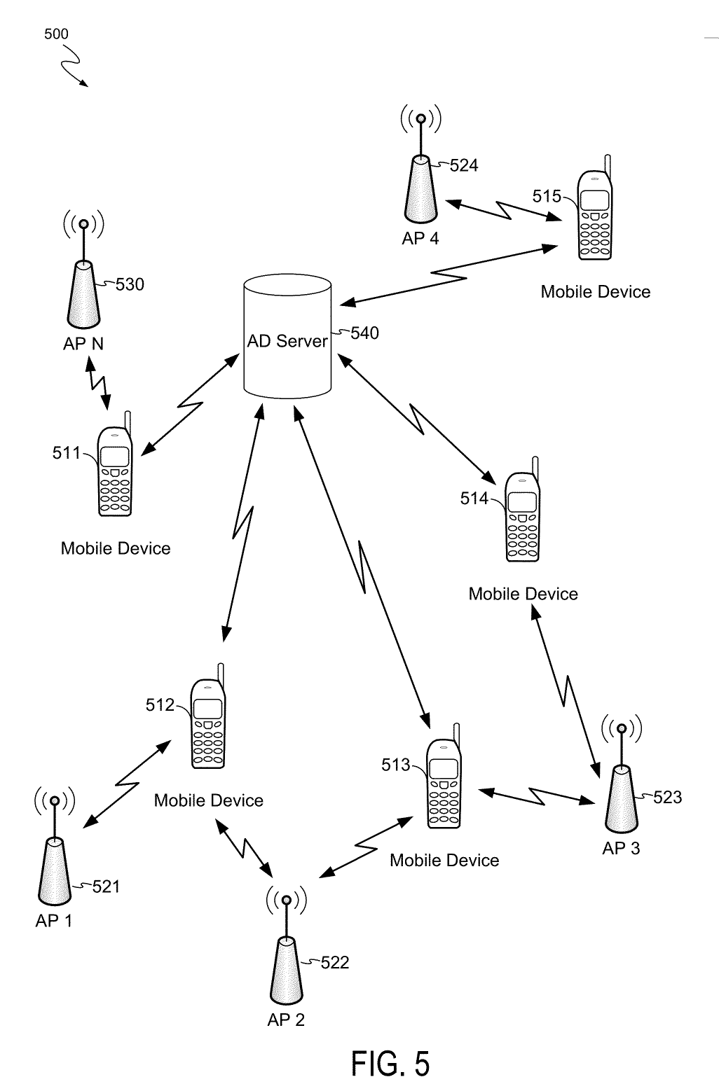

FIG. 5 illustrates another configuration 500 with a plurality of mobile devices, APs and an AD Server. FIG. 5 illustrates a configuration 500 with a plurality of APs (AP 1(521), AP 2(522), AP 3(523), AP 4(524), AP N(530)), a plurality of mobile devices (511, 512, 513, 514 and 515) and an AD server 540. In FIG. 5, embodiments of the invention may use techniques such as crowdsourcing for aggregating data associated with one or more APs. In one implementation, multiple mobile devices may collect data associated with the APs and communicate the data to an AD server 540. The AD server 540 may receive and aggregate data received from multiple mobile devices. The aggregated data may include traffic load information associated with the one or more APs. The AD server 540 may determine the traffic load information associated with each AP using the received data from the mobile devices. Furthermore, the AD server 540 may compile an AD list using assistance data information including traffic load information.

Techniques described herein may enable mobile devices to report back close to real-time traffic load conditions for the APs back to the AD Server 540. The AD Server 540 may dynamically update the AD lists with the traffic load information and send updated AD lists to the mobile devices. Furthermore, the reliability of the traffic load information compiled by the AD Server 540 may increase as the number of mobile devices reporting back the traffic load information with the associated APs increase.

In one implementation, the mobile devices determine the traffic load information associated with an AP by determining the response time for an AP to a mobile device positioning request. In another implementation, the APs may also provide traffic load information to the mobile devices for forwarding the information to the AD Server 540.

The AD Server 540 may transmit AD lists to the mobile devices for determining the most suitable APs to communicate with. The mobile device may initiate communication with the APs based on the traffic load information from the AD lists. In one example, if the APs from the AD list do not respond in a timely manner to the mobile device's requests, the mobile device may try and communicate with APs not on the list or not recommended and may report back to the AD Server 540 so that the new traffic load information may be incorporated in the next compilation of the AD list by the AD Server 540.

In FIG. 5, mobile device 511 is wirelessly coupled to AP N (530), mobile device 512 is wirelessly coupled to AP 1 (521) and AP 2 (522), mobile device 513 is wirelessly coupled to AP 2 (522) and AP 3 (523), mobile device 514 is wirelessly coupled to AP 3 (523) and mobile device 515 is wirelessly coupled to AP 4 (524). In FIG. 5, the mobile devices shown may also be wirelessly coupled to the AD Server 540. The mobile devices may send traffic load information to the AD Server 540 for the APs that the mobile devices are coupled to. For example, the mobile devices may provide the AD Server 540 with the response time of the APs for communication between the mobile device and the AP. The AP may also provide other information to the mobile device for the purpose of forwarding the information back to the AD Server 540. For example, the AP may communicate to the mobile devices factors affecting the response time for the AP, such as number of clients coupled to the AP, number of channels supported by the AP, AP hardware capabilities, etc.

In FIG. 5, in some instances, multiple mobile devices may be coupled to the same APs. For example, mobile device 512 and 513 are coupled to AP 2 (522) and mobile device 513 and 514 are coupled to AP 3 (523). In the case of AP 2 (522), both mobile devices (512 and 513) may return information associated with the traffic load information for AP 2 (522) to the AD Server 540. This may increase the reliability of the traffic load information calculated by the AD Server 540 for each AP with the additional number of data points aggregated by the AD Server 540 for each AP.

FIG. 6 illustrates one embodiment of the AD Server 620, in accordance with some embodiments. In one implementation, the AD Server 620 may be configured to maintain an AD list 625. The AD list 625 may include a plurality of entries that include AD information for APs, each of which corresponds to either a specific access point identified by a corresponding address (e.g., Media Access Control (MAC) address) or an AP number. The AD Server 620 may be implemented using one or more components described in FIG. 13. The AD Server 620 may also include (or alternatively is associated with) a processor 1310 that may create an AD list 625 from information received from mobile devices, APs, controllers and/or any other suitable entities residing on the network.

As shown in FIG. 6, each entry in the AD list 625 may comprise AD information for the APs that includes a number of fields including, but are not limited to, an AP number 611, an address 612, position information 614, traffic load information 616 and rank (or grouping) of the APs 618. The AD Server 620 may identify and index the entries of the AD list using the AP number 611 and/or the address 612 fields. In some implementations, the AP number 611 may be unique amongst a plurality of APs operating within the same coverage area and cataloged by the same AD Server 620, whereas, in one implementation, the address 612 (e.g., MAC address) may be universally unique for each specific AP.

The position information 614 may include relative and global information regarding the positioning of the AP. In one implementation, the mobile device may decode position information 614 from a plurality of entries from the AD list 625 received from the AD Server 620 for the purpose of determining its own position relative to other APs. For example, the mobile device may decode the AD list 625, determine the APs to communicate with for positioning, determine the distance between the mobile device and the APs and triangulate its own position. In one implementation, the mobile device may determine the distance between the mobile device and an AP by calculating the RTT for a signal transmission between the mobile device and the AP.

In one implementation, the mobile device may determine which APs to communicate with for purposes of positioning based on the traffic load information 616 associated with the APs. For example, the mobile device may first communicate with APs with a lighter load based on the traffic load information 616 provided in the AD list 625. In one implementation, the traffic load information 616 for an AP may include statistics, such as the number of mobile devices coupled to the AP, the channels in use by the AP and the traffic load conditions for the AP.

In another implementation, the entries of the AD list 625 that have assistance data information may include ranking for the APs, wherein the rankings are based on the traffic conditions at the AP. For example, a ranking scale from 0-1, with 0 being the lowest traffic and 1 being the highest level of traffic at the AP, may indicate the load information to the mobile devices. The mobile device may use the ranking information to determine which AP to communicate with for positioning.

In one implementation, the AD Server 620 may dynamically group the APs into separate buckets with different traffic loads and rank them against each other. For example, the AD Server 620 may tag the APs using colors, such as green APs indicating APs that have lower traffic loads, red APs with prohibitively high traffic loads and orange APs with traffic loads somewhere in between green and red APs. A mobile device may try communicating with an orange AP in situations where adequate number of green APs are not available for facilitating the positioning protocols for the mobile device.

FIG. 7 illustrates another embodiment of the AD Server 720, in accordance with some embodiments. In one implementation, the AD Server 720 may be configured to maintain an AD list 725 comprising AD information. The fields for the AD information entries described in FIG. 7 may be similar to FIG. 6. For example, functionally, AP number 711, address 712 (e.g., MAC address), position information 714, traffic load information 716 and rank/group information fields may be analogous to similar fields shown in FIG. 6.

In some implementations, instead of or in addition to the traffic load information 716 and rank/group information 718 fields, the AD Server 720 may implicitly embed information regarding the traffic load conditions at the AP by removing the assistance data information entries for the APs with high traffic loads. For example, AD list 625 and AD list 725 may represent AD lists for similar configurations, such as FIG. 1-5. However, the AD Server 720 may altogether remove entries for APs from the AD list 725 that may have high traffic loads or slower response times. For example, referring to FIG. 1, the AD Server 720 may completely remove entries for AP 2 (112), AP 5 (115) and AP N (120). In one embodiment, removing entries with higher traffic loads may enable reducing the size of the AD list.

FIG. 8 illustrates a block diagram for example modules implemented in a mobile device according to one embodiment of the invention. The mobile device may be a computer device implemented using one or more components described in FIG. 13. Modules described in FIG. 8, may be implemented using software, firmware, hardware or any other combination thereof. In one embodiment, the modules described in FIG. 8 may be stored as software modules on a computer-readable medium 800 that may be any magnetic, electronic, optical, or other computer-readable storage medium. In one implementation, the computer-readable storage medium 800 may include an AD list decoding module 802, RTT module 806, AP selection module 804, distance calculation module 808, crowdsourcing module 810, and/or position determination module 812.

AD list decoding module 802 may be configured to receive the AD list from the AD Server and decode the information. For example, the AD list decoding module 802 may parse through the different entries from the AD list to determine the position information and traffic information associated with each of the APs (identified by the AP number and/or address).

AP selection module 804 may be configured to select an access point from a plurality of access points based on traffic load information received from the AD list decoding module 802. AP selection module 804 may select APs having lower traffic congestion and higher bandwidth availability for position determination.

In one embodiment, the mobile device may use RTT for position determination. RTT module 806 may be configured to send and receive RTT communications. The RTT module 806 may send and receive the RTT communications via wireless transceiver. RTT module 806 may be responsible for all facets of the RTT communication including generation of the packet used for the RTT communication and analyzing the received response to the RTT communication. In other variations, other techniques, such as signal strength determination may be used for position determination.

Distance calculation module 808 may be configured to calculate a distance between the mobile device and an AP. The calculated distance may be based on a response time to the RTT communication initiated by RTT module 806. For example, the distance between the mobile device 110 and an AP may be based on the AP's response time to the RTT communication and the speed of the light.

Position determination module 810 may be configured to determine a position of the mobile device. The position determination module 810 may determine the device's position based on the distance calculation by the distance calculation module 808. The locations of the APs may already be known using position information decoded by AD list decoding module 802 from the AD list. Position determination module 810 may determine the position using the location of the APs and the device's distance from the AP (as determined by the distance calculation module 808) using techniques such as triangulation techniques.

Crowdsourcing module 812 may also be optionally implemented in some embodiments of the invention. In some implementations, the crowdsourcing module 812 may be configured to determine the response time for requests from the mobile device to one or more APs. The crowdsourcing module 812 may be further configured to either individually or collectively send information regarding the response time for one or more APs to an AD Server. Other information regarding the one or more APs may also be included as part of the crowdsourcing information from the mobile device to the AD Server. The AD Server may use the received information from the mobile device in generating an updated and dynamic AD list. The AD Server may transmit the updated and dynamic AD list to other mobile devices in the area for improved position calculations.

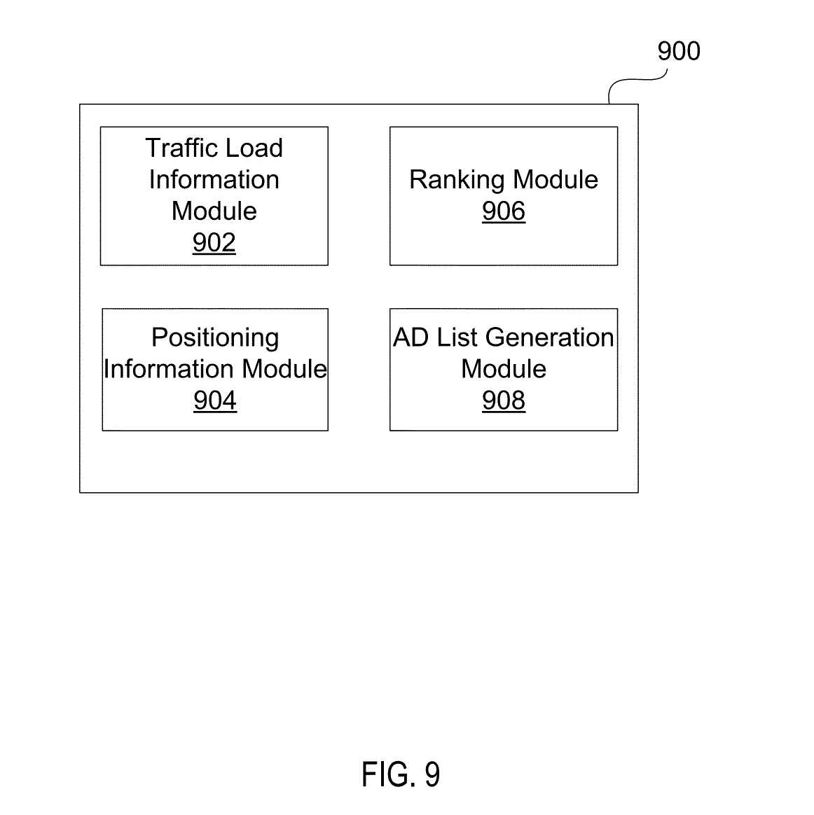

FIG. 9 illustrates a block diagram for example modules implemented in an AD Server according to one embodiment of the invention. The AD Server may be a server computer implemented using one or more components described in FIG. 13. Modules described with reference to FIG. 9, may be implemented in software, firmware, hardware or any other combination thereof. In one embodiment, the modules described in FIG. 9 may be stored as software modules on a computer-readable medium 900 that may be any magnetic, electronic, optical, or other computer-readable storage medium. In one implementation, the computer-readable storage medium 900 may include a traffic load information module 902, a position information module 904, ranking module 906, and an AD list generation module 908.

The modules described in FIG. 9 and implemented as part of an AD Server may receive information from various entities, such as APs, mobile devices and controllers and generate an AD list for use by the mobile devices in selecting which AP to communicate with out of a plurality of APs. Examples of AD lists may be found in FIG. 6 and FIG. 7.

Traffic load information module 902 may determine the traffic load information field associated with each assistance data information entry of the AD list. Each entry of the AD list is associated with an AP. As discussed in FIGS. 1-5, the traffic load information module 902 may receive traffic load information associated with one or more APs in a coverage area from a variety of sources, such as the mobile devices, APs and/or a controller. For example, in one implementation, the controller may already have traffic load information associated with the APs connected to that controller. The controller may send the traffic load information for the APs to the AD Server. In another example, the APs themselves may transmit their traffic load conditions and other assistance data information to the AD Server. In yet another example, the mobile devices may send traffic load information based on their interaction with the various APs to the AD Server. Traffic load information for each AP may include a number of mobile devices connected to the AP, the number of channels supported by the AP and the traffic load associated with the various communication requests.

Positioning information module 904 may determine the position information field associated with each AD information entry of the AD list, wherein each entry of the AD list represents an AP. The position information may include relative or global information associated with the location of an AP with respect to a local or global coordinate system. For example, in one embodiment, position information for an AP may include absolute location of an AP within a grid that may include three dimensions of information. The grid or coordinate system may be specific to a specific indoor venue, such as a shopping mall or a library.

Ranking module 906 may use the traffic load information associated with each AP and provide a ranking for each AP. In some implementations, the ranking may be represented using a numerical value. Various different scales may be used for ranking the APs, such as 0-1, 1-10, percentage scale, or any other suitable method. In another implementation, the ranking module 906 may group the APs into a number of groups or buckets ranked against each other. For example, in one implementation, the APs may be tagged or labeled as one of green, orange and red APs. The green APs may signify APs with lower traffic loads, the orange APs may signify APs with higher traffic loads, and red APs may signify APs with prohibitively high traffic loads or APs that should not be used for the positioning protocol. The mobile device may decode this labeling and communicate with green APs followed by orange APs in scenarios where enough green APs are not available for positioning. The mobile devices may refrain from communicating with the red APs for positioning purposes.

In some implementations, the entries in the AD list may include traffic load information, ranking information or both. For example, in some implementations, the traffic load information may be sent to the mobile device for further processing by the mobile device. The mobile device may rank the APs and select the APs for communication. In other implementations, the AD Server may derive the ranking information using the traffic load information and include only the ranking information in the AD list. However, in yet other implementations, the AD Server may include both traffic load information and ranking information in the entries of the AD list.

AD list generation module 908 may receive information associated with each AP and generate the AD list for transmission to the mobile device. The AD list generation module 908 may receive one or more of the traffic load information, position information, and ranking information associated with an AP. The AD list generation module may then generate an entry for the AD list by associating the information with a unique AP number and/or the address (as shown in FIG. 6 and FIG. 7) for the AP. The AD list generation module 908 may generate entries in the AD list for all the APs that the AD list generation module 908 is able to access. The AD Server may communicate the updated AD list to one or more mobile devices in the coverage area.

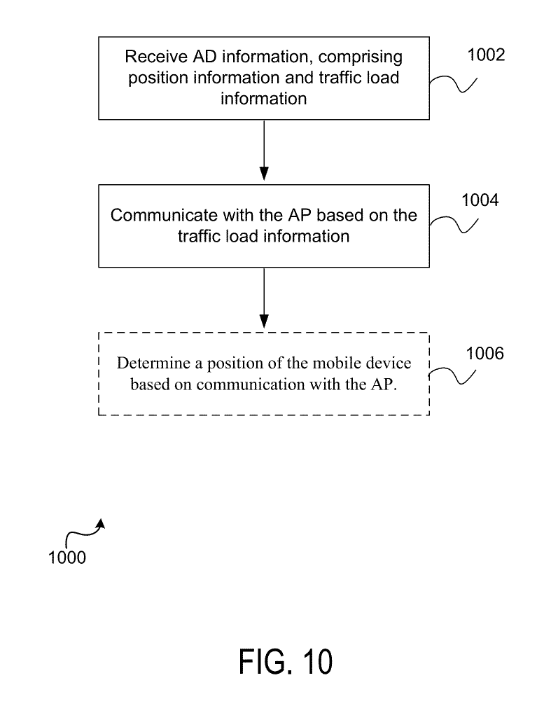

FIG. 10 is a flow diagram illustrating a method for performing embodiments of the invention according to one or more illustrative aspects of the disclosure. According to one or more aspects, any and/or all of the methods and/or method steps described in the flow diagram 1000 illustrated in FIG. 10, may be implemented by a mobile device, such as the mobile device described in greater detail in FIG. 13, for instance. In one embodiment, one or more of the method steps described below with respect to FIG. 10 are implemented by a processor of the mobile device, such as the processor 1310 or another processor. Modules and components discussed in FIG. 8, may also be implemented as components of the mobile device and may be used in performing embodiments of the invention as discussed in FIG. 13. Additionally or alternatively, any and/or all of the methods and/or method steps described herein may be implemented in computer-readable instructions, such as computer-readable instructions stored on a computer-readable medium such as the memory 1335, storage 1325 or another computer readable medium.

At step 1002, components of the mobile device, may receive assistance data information via a transceiver as part of the communications subsystem 1330. The received assistance data information may include position information and traffic load information associated with an AP. In one embodiment, the traffic load information for the AP may include one or more of the number of mobile devices connected to the at least one AP, the number of APs operating over a frequency channel used by the AP, and the amount of traffic on the frequency channel.

In one embodiment, the controller has the traffic load information associated with the APs coupled to the controller. The controller may send traffic load information to the AD Server, as shown in FIG. 2. In another implementation, as shown in FIG. 5, a plurality of mobile devices may send the traffic load information to the AD Server. In yet another implementation, the AP itself may send traffic load information to the AD Server. The AD Server may receive the traffic load information and compile the information into assistance data information. In some implementations, the AD Server may generate an AD list that comprises assistance data information for a plurality of APs. The AD Server may send the assistance data to the mobile device. The assistance data information that includes traffic load information may be communicated to the mobile device entering the service area by a designated AP. The traffic load information may be dynamic, and as the traffic load conditions for the AP changes, new traffic load information may be forwarded to the AD Server for incorporation into the assistance data information.

At step 1004, components of the mobile device, may communicate with an AP via the transceiver, at least based on the traffic load information from the AD information associated with the at least one AP.

In one embodiment, components of the mobile device may perform retries for communicating with the AP based on the traffic load information associated with the AP. In one implementation, the number of retries performed by the mobile device for communicating with the AP may be inversely proportional to the traffic load information associated with the AP. For example, if the AD information for an AP indicates that the AP has a high traffic load then the mobile device may limit the number of retries to the AP to a predetermined low number. However, if the AD information for an AP indicates that AP has a very low traffic load then the mobile device may continue to retry the AP with requests until a response is received or a predetermined high threshold for retries or timeout is met.

At step 1006, components of the mobile device, such as the position determination module 810, may determine a position of the mobile device based on the communication with the AP. Therefore, in one embodiment, communicating with the AP, in step 1004, may include exchanging information with the AP for determining the position of the mobile device. Typically, for determining the position of the mobile device, the mobile device may communicate with three or more APs to triangulate its own position.

Although embodiments of the invention describe using the traffic load information for selecting one or more APs to communicate with for the purpose of determining the position of the mobile device, the mobile device may also communicate with the AP for purposes of connecting to a data network. For example, the mobile device may access the internet or the intranet using the AP.

In one embodiment, the AD information may include position information and traffic load information associated with not only one AP, but multiple APs in the form of an AD list. The AD list may include a number of AD entries, wherein each AD information entry is associated with the position information and traffic load information for the AP.

In one implementation, the mobile device may determine if the plurality of APs included in the AD list are more than a predetermined number. For example, in some implementations the mobile device may use three or more APs for triangulating the position of the mobile device. In response to determining that the plurality of APs are more than the predetermined number, the mobile device may rank the plurality of APs based on at least the traffic load information, and communicate with the at least one AP from the plurality of APs based on the ranking of the plurality of the APs. In one implementation, the traffic load information associated with the APs is indicated by assigning a numeric value to each of the APs in the assistance data. The AD Server maintains the assistance data and periodically communicates the updated assistance data information to the mobile device.

It should be appreciated that the specific steps illustrated in FIG. 10 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

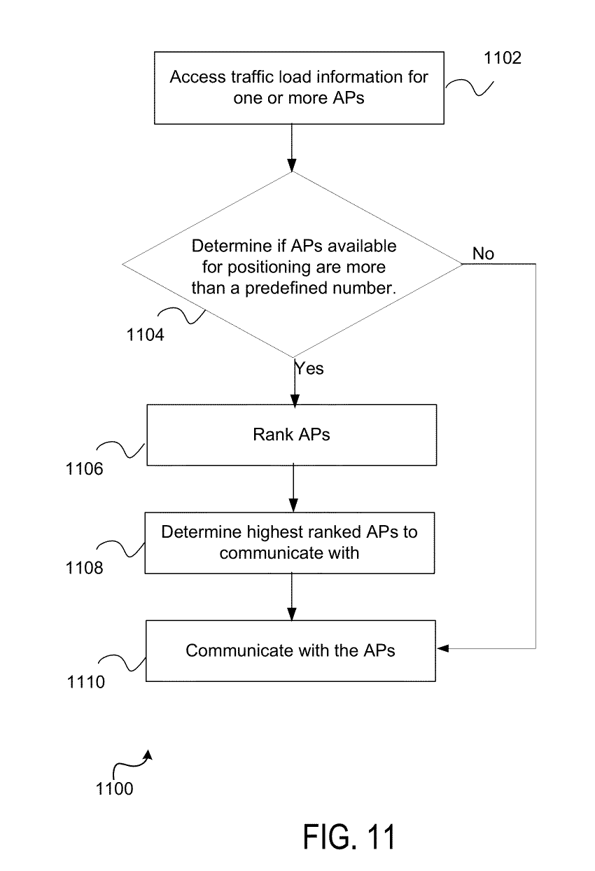

FIG. 11 is another flow diagram illustrating a method for performing embodiments of the invention according to one or more illustrative aspects of the disclosure. According to one or more aspects, any and/or all of the methods and/or method steps described in the flow diagram 1100 illustrated in FIG. 11, may be implemented by and/or in a mobile device, such as the mobile device described in greater detail in FIG. 13, for instance. In one embodiment, one or more of the method steps described below with respect to FIG. 11 are implemented by a processor of the mobile device, such as the processor 1310 or another processor. Modules and components discussed in FIG. 8, may also be implemented as components of the mobile device and may be used in performing embodiments of the invention as discussed in FIG. 11. Additionally or alternatively, any and/or all of the methods and/or method steps described herein may be implemented in computer-readable instructions, such as computer-readable instructions stored on a computer-readable medium such as the memory 1335, storage 1325 or another computer readable medium.

At step 1102, the mobile device may access traffic load information for one or more APs. In one embodiment, the mobile device may receive AD information associated with one or more APs in the form of an AD list. The AD list may include a plurality of entries, wherein each entry may include position information fields and rank fields.

At step 1104, the mobile device may determine if the APs available for positioning are more than a predefined number. For example, if the mobile device detects only three APs, the mobile device may use all three APs in the positioning protocol irrespective of the traffic load associated with each AP. Therefore, if the number of APs available for positioning are equal to or less than a pre-determined number, then in one implementation the mobile devices may start communicating with the APs at step 1110. However, if the number of APs available for positioning are more than the pre-determined number, the mobile device may start ranking the APs at the mobile device (step 1106).

At step 1106, the mobile device may rank the APs using the traffic load information associated with each AP. The traffic load information may include the number of mobile devices coupled to the AP, the number of channels supported by the AP and the traffic conditions for the AP. In some implementations, the ranking may be represented using a numerical value. Various different scales may be used for ranking the APs, such as 0-1, 1-10, percentage scale, or any other suitable method. In another implementation, the mobile device may group the APs into a number of groups or buckets ranked against each other. In some implementations, the ranking functionality may be performed in the mobile device, as described here. However, in other variations, the ranking functionality may be performed at the AD Server.

At step 1108, the mobile device may determine the highest ranked APs with which to communicate. At step 1110, the mobile device may communicate with the APs. For example, the mobile device may communicate with APs identified as APs with lower traffic loads and refrain from communicating with APs identified as APs with higher traffic loads.

It should be appreciated that the specific steps illustrated in FIG. 11 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 11 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

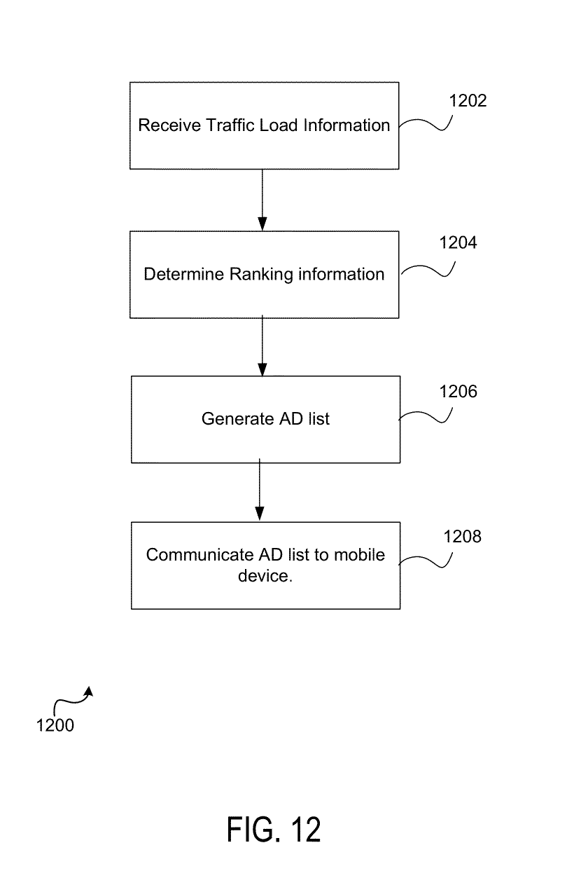

FIG. 12 is a flow diagram illustrating a method for performing embodiments of the invention according to one or more illustrative aspects of the disclosure. According to one or more aspects, any and/or all of the methods and/or method steps described in the flow diagram 1200 illustrated in FIG. 12, may be implemented by and/or in an AD Server, components of which are described in greater detail in FIG. 13, for instance. The AD Server is an example of a server computer. In one embodiment, one or more of the method steps described below with respect to FIG. 12 are implemented by a processor of the AD Server, such as the processor 1310 or another processor. Modules and components discussed in FIG. 9 may also be implemented as components of the AD Server and may be used in performing embodiments of the invention as discussed in FIG. 12. Additionally or alternatively, any and/or all of the methods and/or method steps described herein may be implemented in computer-readable instructions, such as computer-readable instructions stored on a computer-readable medium such as the memory 1335, storage 1325 or another computer readable medium.

At step 1202, the AD Server may access traffic load information for one or more APs. The AD Server may determine the traffic load information field associated with each entry of the AD list, as shown in FIG. 6 and FIG. 7. As discussed in FIGS. 1-5, the traffic load information associated with various APs in a coverage area may be received from a variety of entities, such as the mobile devices, APs and/or a controller. For example, in one implementation, the controller coupled to the APs may already have traffic load information associated with the APs. In another example, the APs themselves may transmit their traffic load conditions and information to the AD Server. In yet another example, the mobile devices may send traffic load information based on their interaction with the various APs to the AD Server. Traffic load information may include a number of mobile devices connected to the AP, the number of channels supported by the AP and the traffic load associated with the various communication requests.

At step 1204, the AD Server, in some implementations, may also determine the ranking information for the APs. In one implementation, the AD Server may use the traffic load information associated with each AP and provide a ranking for each AP. In some implementations, the ranking may be represented using a numerical value. Various different scales may be used for ranking the APs, such as 0-1, 1-10, percentage scale, or any other suitable method. In another implementation, the AD Server may group the APs into a number of groups or buckets ranked against each other. For example, in one implementation, the APs may be tagged or labeled as one of green, orange and red APs. The green APs may signify APs with lower traffic loads, the orange APs may signify APs with higher traffic loads, and red APs may signify APs with prohibitively high traffic loads or APs that are preferably not used for the positioning protocol. The mobile device may decode these tags and communicate with green APs followed by orange APs in scenarios where enough green APs are not available. The mobile devices may refrain from communicating with the red APs for positioning purposes, unless enough green and orange APs are not available for determining the position of the mobile device.

At step 1206, the AD Server may generate the AD list. AD Server may receive information associated with each AP and generate the AD list for later transmission to the mobile device. The AD Server may receive one or more of the traffic load information, position information, and ranking information associated with an AP and generate an entry for the AD list by associating the information with a unique AP number and/or the address (as shown in FIG. 6 and FIG. 7) for the AP. The AD Server may generate entries in the AD list for all the APs that the AD Server may be able to access. At step 1208, the AD Server may communicate the updated AD list to one or more mobile devices in the coverage area.

It should be appreciated that the specific steps illustrated in FIG. 12 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

FIG. 13 illustrates an example computing device incorporating parts of the device employed in practicing embodiments of the invention. A computing device as illustrated in FIG. 13 may be incorporated as part of any computerized system, herein. For example, computing device 1300 may represent some of the components of a mobile device, AD Server, AP, or the controller. Examples of a computing device 1300 include, but are not limited to, video game consoles, tablets, smart phones, laptops, netbooks, or other portable devices. FIG. 13 provides a schematic illustration of one embodiment of a computing device 1300 that may perform the methods provided by various other embodiments, as described herein, and/or may function as the host computing device, a remote kiosk/terminal, a point-of-sale device, a mobile multifunction device, a set-top box and/or a computing device. FIG. 13 is meant only to provide a generalized illustration of various components, any or all of which may be utilized as appropriate. FIG. 13, therefore, broadly illustrates how individual system elements may be implemented in a relatively separated or relatively more integrated manner.

The computing device 1300 is shown comprising hardware elements that may be electrically coupled via a bus 1305 (or may otherwise be in communication, as appropriate). The hardware elements may include one or more processors 1310, including without limitation one or more general-purpose processors and/or one or more special-purpose processors (such as digital signal processing chips, graphics acceleration processors, and/or the like); one or more input devices 1315, which may include without limitation a camera, sensors 1350, a mouse, a keyboard and/or the like; and one or more output devices 1320, which may include without limitation a display unit, a printer and/or the like.

The computing device 1300 may further include (and/or be in communication with) one or more non-transitory storage devices 1325, which may comprise, without limitation, local and/or network accessible storage, and/or may include, without limitation, a disk drive, a drive array, an optical storage device, a solid-form storage device such as a random access memory (“RAM”) and/or a read-only memory (“ROM”), which may be programmable, flash-updateable and/or the like. Such storage devices may be configured to implement any appropriate data storage, including without limitation, various file systems, database structures, and/or the like.

The computing device 1300 might also include a communications subsystem 1330. The communications subsystem 1330 may include a transceiver for receiving and transmitting data or a wired and/or wireless medium. The communications subsystem 1330 may also include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1330 may permit data to be exchanged with a network (such as the network described below, to name one example), other computing devices, and/or any other devices described herein. In many embodiments, the computing device 1300 will further comprise a non-transitory working memory 1335, which may include a RAM or ROM device, as described above.

The computing device 1300 may comprise software elements, shown as being currently located within the working memory 1335, including an operating system 1340, device drivers, executable libraries, and/or other code, such as one or more application programs 1345, which may comprise computer programs provided by various embodiments, and/or may be designed to implement methods, and/or configure systems, provided by other embodiments, as described herein. In one implementation, components or modules of FIG. 8 and FIG. 9 may be performed using such software elements. Merely by way of example, one or more procedures described with respect to the method(s) discussed above might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a computer-readable storage medium, such as the storage device(s) 1325 described above. In some cases, the storage medium might be incorporated within a computing device, such as computing device 1300. In other embodiments, the storage medium might be separate from a computing device (e.g., a removable medium, such as a compact disc), and/or provided in an installation package, such that the storage medium may be used to program, configure and/or adapt a general purpose computer with the instructions/code stored thereon. These instructions might take the form of executable code, which is executable by the computing device 1300 and/or might take the form of source and/or installable code, which, upon compilation and/or installation on the computing device 1300 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices 1300 such as network input/output devices may be employed.

Some embodiments may employ a computing device (such as the computing device 1300) to perform methods in accordance with the disclosure. For example, some or all of the procedures of the described methods may be performed by the computing device 1300 in response to processor 1310 executing one or more sequences of one or more instructions (which might be incorporated into the operating system 1340 and/or other code, such as an application program 1345) contained in the working memory 1335. Such instructions may be read into the working memory 1335 from another computer-readable medium, such as one or more of the storage device(s) 1325. Merely by way of example, execution of the sequences of instructions contained in the working memory 1335 might cause the processor(s) 1310 to perform one or more procedures of the methods described herein.

The terms “machine-readable medium” and “computer-readable medium,” as used herein, refer to any medium that participates in providing data that causes a machine to operate in a specific fashion. In an embodiment implemented using the computing device 1300, various computer-readable media might be involved in providing instructions/code to processor(s) 1310 for execution and/or might be used to store and/or carry such instructions/code (e.g., as signals). In many implementations, a computer-readable medium is a physical and/or tangible storage medium. Such a medium may take many forms, including, but not limited to, non-volatile media, volatile media, and transmission media. Non-volatile media include, for example, optical and/or magnetic disks, such as the storage device(s) 1325. Volatile media include, without limitation, dynamic memory, such as the working memory 1335. Transmission media include, without limitation, coaxial cables, copper wire and fiber optics, including the wires that comprise the bus 1305, as well as the various components of the communications subsystem 1330 (and/or the media by which the communications subsystem 1330 provides communication with other devices). Hence, transmission media may also take the form of waves (including without limitation radio, acoustic and/or light waves, such as those generated during radio-wave and infrared data communications). In an alternate embodiment, event-driven components and devices, such as cameras, may be used, where some of the processing may be performed in analog domain.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer may read instructions and/or code.

Various forms of computer-readable media may be involved in carrying one or more sequences of one or more instructions to the processor(s) 1310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computing device 1300. These signals, which might be in the form of electromagnetic signals, acoustic signals, optical signals and/or the like, are all examples of carrier waves on which instructions may be encoded, in accordance with various embodiments of the invention.

The communications subsystem 1330 (and/or components thereof) generally will receive the signals, and the bus 1305 then might carry the signals (and/or the data, instructions, etc. carried by the signals) to the working memory 1335, from which the processor(s) 1310 retrieves and executes the instructions. The instructions received by the working memory 1335 may optionally be stored on a non-transitory storage device 1325 either before or after execution by the processor(s) 1310.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method for selecting at least one access point (AP) from a plurality of APs for determining position of a mobile device, comprising:
receiving, at the mobile device, assistance data (AD) information, wherein the AD information comprises position information and traffic load information associated with the at least one AP from the plurality of APs; and
communicating with the at least one AP based on the traffic load information.

2. The method of claim 1, wherein communicating further comprises exchanging information with the at least one AP for accessing information from a data network.

3. The method of claim 1, wherein the traffic load information for the at least one AP comprises one or more of a number of mobile devices connected to the at least one AP, a number of other APs operating over a frequency channel used by the at least one AP, and amount of traffic on the frequency channel.

4. The method of claim 1, wherein the traffic load information for the at least one AP originated from one or more of a controller, a second mobile device and the at least one AP.

5. The method of claim 1, wherein the AD information comprising the traffic load information associated with the at least one AP is communicated by an AP to the mobile device.

6. The method of claim 1, further comprising performing retries for communicating with the at least one AP based on the traffic load information, wherein a number of retries for communicating with the at least one AP is inversely proportional to the traffic load information associated with the at least one AP.

7. The method of claim 1, wherein the AD information comprises the position information and the traffic load information associated with the plurality of APs.

8. The method of claim 7, wherein communicating with the at least one AP further comprises:
determining if the plurality of APs are more than a predetermined number;
in response to determining that the plurality of APs are more than the predetermined number, ranking the plurality of APs based on the traffic load information; and
communicating with the at least one AP from the plurality of APs based on the ranking of the plurality of the APs.

9. The mobile device of claim 7, wherein the traffic load information associated with the plurality of APs is indicated by assigning a numeric value to each of the plurality of APs in the AD information.

10. The method of claim 1, wherein the AD information is stored at an assistance data server and is communicated to the mobile device by the assistance data server.

11. A mobile device for selecting at least one access point (AP) from a plurality of APs for determining position of the mobile device, comprising:
a processor coupled to memory;
a transceiver configured to:
receive assistance data (AD) information, wherein the AD information comprises position information and traffic load information associated with the at least one AP from the plurality of APs; and
communicate with the at least one AP from the plurality of APs, based on the traffic load information for determining the position of the mobile device.

12. The mobile device of claim 11, wherein communicating further comprises exchanging information with the at least one AP for accessing information from a data network.

13. The mobile device of claim 11, wherein the traffic load information for the at least one AP comprises one or more of a number of mobile devices connected to the at least one AP, a number of APs operating over a frequency channel used by the at least one AP, and amount of traffic on the frequency channel.

14. The mobile device of claim 11, wherein the traffic load information for the at least one AP originated from one or more of a controller, a second mobile device, and the at least one AP.

15. The mobile device of claim 11, wherein the AD information comprising the traffic load information associated with the at least one AP is communicated by an AP to the mobile device.

16. The mobile device of claim 11, further comprising the processor performing retries for communicating with the at least one AP based on the traffic load information, wherein a number of retries for communicating with the at least one AP is inversely proportional to the traffic load information associated with the at least one AP.

17. The mobile device of claim 11, wherein the AD information comprises the position information and the traffic load information associated with the plurality of APs.

18. The mobile device of claim 17, wherein communicating with the at least one AP further comprises:
the processor configured to determine if the plurality of APs are more than a predetermined number;
in response to determining that the plurality of APs are more than the predetermined number, the processor further configured to rank the plurality of APs based on the traffic load information; and
the transceiver configured to communicate with the at least one AP from the plurality of APs based on the ranking of the plurality of the APs.

19. The mobile device of claim 17, wherein the traffic load information associated with the plurality of APs is indicated by assigning a numeric value to each of the plurality of APs in the AD information.

20. The mobile device of claim 15, wherein the AD information is stored at an assistance data server and is communicated to the mobile device by the assistance data server.

21. A method for transmitting traffic load information for at least one access point (AP) from a plurality of APs for determining position of a mobile device, the method comprising:
receiving, at a server computer, traffic load information associated with the at least one AP from the plurality of APs;
generating, at the server computer, an assistance data (AD) list comprising assistance data (AD) information, wherein the AD information comprises position information and the traffic load information associated with the at least one AP from the plurality of APs; and
transmitting, by the server computer, the AD list for delivery to the mobile device, wherein the traffic load information from the AD list is used by the mobile device in selecting the at least one AP for communicating with for determining the position of the mobile device.

22. The method of claim 21, wherein the traffic load information for the at least one AP comprises one or more of a number of mobile devices connected to the at least one AP, a number of APs operating over a frequency channel used by the at least one AP, and amount of traffic on the frequency channel.

23. The method of claim 21, wherein the traffic load information for the at least one AP is received from one or more of a controller, a second mobile device, or the at least one AP.

24. The method of claim 21, wherein the AD list comprises the position information and the traffic load information associated with the plurality of APs.

25. The method of claim 24, wherein generating the AD list further comprises:
ranking, by the server computer, the plurality of APs based on the traffic load information associated with each of the plurality of APs; and
including, by the server computer, the ranking information for each of the plurality of APs in the AD list.

26. A server computer for transmitting traffic load information for at least one access point (AP) from a plurality of APs for determining position of a mobile device, comprising:
a transceiver configured to receive traffic load information associated with the at least one access point (AP) from the plurality of APs;
a processor coupled to memory and configured to generate an assistance data (AD) list comprising assistance data (AD) information, wherein the AD information comprises position information and the traffic load information associated with the at least one AP from the plurality of APs; and
the transceiver further configured to transmit the AD list for delivery to the mobile device, wherein the traffic load information from the AD list is used by the mobile device in selecting the at least one AP for communicating with for determining position of the mobile device.

27. The server computer of claim 26, wherein the traffic load information for the at least one AP comprises one or more of a number of mobile devices connected to the at least one AP, a number of APs operating over a frequency channel used by the at least one AP, and amount of traffic on the frequency channel.

28. The server computer of claim 26, wherein the traffic load information for the at least one AP is received by the transceiver from one or more of a controller, a second mobile device, or the at least one AP.

29. The server computer of claim 26, wherein the AD list comprises the position information and the traffic load information associated with the plurality of APs.

30. The server computer of claim 29, wherein generating the AD list comprises the processor further configured to:
rank the plurality of APs based on the traffic load information associated with each of the plurality of APs; and
include the ranking information for each of the plurality of APs in the AD list.
